(19) United States
(12) Patent Application Publication
(10) Pub. No.: US 2024/0104768 A1
(43) Pub. Date: Mar. 28, 2024

(54) ARTICLE DETECTION DEVICE, CALIBRATION METHOD, AND ARTICLE DETECTION METHOD

(71) Applicants: National Institute of Advanced Industrial Science and Technology, Tokyo (JP); KABUSHIKI KAISHA TOYOTA JIDOSHOKKI, Kariya-shi (JP)

(72) Inventors: Nobuyuki KITA, Tsukuba-shi (JP); Takuro Kato, Tsukuba-shi (JP); Daisuke Okabe, Tsukuba-shi (JP); Eiichi Yoshida, Tsukuba-shi (JP); Yukikazu Koide, Tsukuba-shi (JP); Norihiko Kato, Tsukuba-shi (JP); Naoya Yokomachi, Kariya-shi (JP); Tatsuya Komuro, Kariya-shi (JP)

(73) Assignees: National Institute of Advanced Industrial Science and Technology, Tokyo (JP); KABUSHIKI KAISHA TOYOTA JIDOSHOKKI, Kariya-shi (JP)

(21) Appl. No.: 18/474,552

(22) Filed: Sep. 26, 2023

(30) Foreign Application Priority Data
Sep. 28, 2022 (JP) 2022-154676

(51) Int. Cl. G06T 7/73; B66F 9/075; G06T 7/13

(52) U.S. Cl. CPC G06T 7/73; B66F 9/0755; G06T 7/13; G06T 2207/20061; G06T 2207/30252

(57) ABSTRACT

An article detection device includes: an image acquiring unit acquiring a surroundings image; a first information image preparing unit preparing a first information image by converting information on a load/unloading target portion of the article to an easily recognizable state based on the surroundings image; a first calculation unit calculating at least one of a position and a posture of the load/unloading target portion; a second information image preparing unit preparing a second information image by converting information on a pitch angle detection portion of the article to an easily recognizable state; and a second calculation unit configured extracting at least two edge candidates for the article extending in a specific direction and included in the second information image based on a calculation result from the first calculation unit and calculating a three-dimensional direction vector indicating a pitch angle of the article from the edge candidates.

### CROSS REFERENCE TO RELATED APPLICATIONS

This application claims priority to Japanese Patent Application No. 2022-154676 filed on Sep. 28, 2022, the entire contents of which are incorporated by reference herein.

### TECHNICAL FIELD

The present disclosure relates to an article detection device and an article detection method.

### BACKGROUND

For example, a technique described in PCT International Publication No. 2020/189154 is known as an article detection device according to the related art. The article detection device described in PCT International Publication No. 2020/189154 includes an image acquiring unit configured to acquire a surroundings image by imaging the surroundings of the article detection device, an information image preparing unit configured to prepare an information image by converting information on a loading/unloading target portion of an article to an easily recognizable state, and a calculation unit configured to calculate a position and a posture of the loading/unloading target portion.

### SUMMARY

In the technique described in PCT International Publication No. 2020/189154, the article detection device can calculate a position and a posture of a loading/unloading target portion of an article such as a pallet. However, since a hole in a pallet into which a fork is inserted extends in a longitudinal direction, the fork may not be able to be properly inserted into the hole when the pallet is tilted at a predetermined pitch angle. Accordingly, there is demand for easily acquiring a pitch angle of an article.

Therefore, an objective of the present disclosure is to provide an article detection device, a calibration method, and an article detection method that can easily acquire a pitch angle of an article which is a loading/unloading target.

According to an aspect of the present disclosure, there is provided an article detection device that detects an article to be loaded/unloaded, the article detection device including: an image acquiring unit configured to acquire a surroundings image by imaging surroundings of the article detection device; a first information image preparing unit configured to prepare a first information image by converting information on a load/unloading target portion of the article to an easily recognizable state based on the surroundings image; a first calculation unit configured to calculate at least one of a position and a posture of the load/unloading target portion based on the first information image; a second information image preparing unit configured to prepare a second information image by converting information on a pitch angle detection portion of the article to an easily recognizable state; and a second calculation unit configured to extract at least two edge candidates for the article extending in a specific direction and included in the second information image based on a calculation result from the first calculation unit and to calculate a three-dimensional direction vector indicating a pitch angle of the article from the edge candidates.

In this article detection device, the first calculation unit can calculate at least one of a position and a posture of a load/unloading target portion based on the first information image. The article detection device includes the second information image preparing unit configured to prepare a second information image by converting information on the pitch angle detection portion of the article to an easily recognizable state. Here, when at least two edge candidates extending in a specific direction are extracted from the second information image, a three-dimensional direction vector indicating the specific direction can be calculated. A three-dimensional direction vector indicating the pitch angle of the article can be calculated based on the three-dimensional direction vector indicating the specific direction. Accordingly, the article detection device includes the second calculation unit configured to extract at least two edge candidates for the article extending in the specific direction from the second information image based on the calculation result from the first calculation unit and to calculate the three-dimensional direction vector indicating the pitch angle of the article based on the edge candidates. As a result, it is possible to easily calculate a pitch angle of an article from a surroundings image without using a particular sensor or the like. Accordingly, it is possible to easily acquire a pitch angle of an article which is a loading/unloading target.

The second information image preparing unit may prepare the second information image in a first case in which luggage is piled on the article and a second case in which luggage is not piled on the article in preparing the second information image, the second information image preparing unit may prepare the second information image with a zenith direction of the image acquiring unit as a central axis in the first case, and the second information image preparing unit may prepare the second information image with an optical axis direction of the image acquiring unit as a central axis in the second case. Accordingly, the second calculation unit can calculate a pitch angle of an article regardless of whether luggage is piled on the article.

The second calculation unit may extract the edge candidates from one side and the other side in a transverse direction of a loading/unloading target in the second information image. Accordingly, the second calculation unit can easily extract edge candidates from easily extractable positions.

The second information image preparing unit may prepare both the second information image with the zenith direction as a central axis and the second information image with the optical axis direction as a central axis, and the second calculation unit may employ a result of the second information image with the optical axis direction as a central axis when results of both the second information images are effective. When the zenith direction is set as the central axis, the background includes many edges and thus accuracy is poor. Accordingly, the second calculation unit can more accurately calculate a pitch angle by preferentially employing the result of the second information image with the optical axis direction as the central axis.

The second calculation unit may perform Hough transformation of edge points in a specific area for extracting the edge candidates in the second information image and determine that the edge candidates are present in the specific area when a length of an acquired straight line is equal to or greater than a predetermined length. Accordingly, the second calculation unit can easily determine whether an edge candidate is present.

According to another aspect of the present disclosure, there is provided a calibration method for an image acquiring unit used in an article detection device, the calibration method including: a step of disposing a calibration panel on a fork; a step of aligning a central portion of the panel with the origin of a fork coordinate system; a step of preparing a second information image by converting information on directions of longitudinal and transverse edges of the panel to an easily recognizable state; a step of extracting a longitudinal edge of the panel included in the second information image; and a step of extracting a transverse edge of the panel included in the second information image.

With this calibration method, a positional relationship between a fork coordinate system and a camera coordinate system can be ascertained from a positional relationship of the panel in the camera coordinate system by disposing the panel on the fork and aligning them. The step of extracting a longitudinal edge of the panel included in the second information image and the step of extracting a transverse edge of the panel included in the second information image are performed. Accordingly, it is possible to more accurately ascertain the positional relationship of the panel in the camera coordinate system. As a result, it is possible to accurately convert the camera coordinate system to the fork coordinate system.

According to another aspect of the present disclosure, there is provided an article detection method of detecting an article to be loaded/unloaded, the article detection method including: an image acquiring step of acquiring a surroundings image by imaging the surroundings of the article detection device; a first information image preparing step of preparing a first information image by converting information on a load/unloading target portion of the article to an easily recognizable state based on the surroundings image; a first calculation step of calculating at least one of a position and a posture of the load/unloading target portion based on the first information image; a second information image preparing step of preparing a second information image by converting information on a pitch angle detection portion of the article to an easily recognizable state; and a second calculation step of extracting at least two edge candidates for the article extending in a specific direction and included in the second information image based on a calculation result from the first calculation step and calculating a three-dimensional direction vector indicating a pitch angle of the article from the edge candidates.

With the article detection method, the same operations and advantages as in the article detection device can be achieved.

According to the present disclosure, it is possible to provide an article detection device, a calibration method, and an article detection method that can easily acquire a pitch angle of an article which is a loading/unloading target.

### BRIEF DESCRIPTION OF THE DRAWINGS

FIG. 1 is a side view of a forklift including an article detection device according to an embodiment of the present disclosure.

FIG. 2 is a block diagram illustrating a configuration of the article detection device illustrated in FIG. 1 and constituents thereof.

FIG. 3 is a diagram illustrating a state in a step before a fork is inserted into a hole of a front surface of a pallet on a mount in front of the forklift.

FIG. 4 is a diagram illustrating an example of a surroundings image.

FIG. 5A is a perspective view illustrating a state in which a feature plane is set for a rack and FIG. 5B is a plan view schematically illustrating a positional relationship between the feature plane and a plurality of viewpoints V1, V2, and V3.

FIG. 6 is a diagram illustrating a first information image which is prepared using the feature plane.

FIG. 7 is a diagram illustrating a panoramic image.

FIG. 8A is a diagram illustrating a detected edge point line and FIG. 8B is a diagram illustrating scores of edge points in a parameter space subjected to Hough transformation.

FIG. 9A is a diagram illustrating process details when luggage is piled on a pallet and FIG. 9B is a diagram illustrating process details when luggage is not piled on the pallet.

FIG. 10 is a diagram illustrating a panoramic image with a zenith direction of an imaging unit as a central axis.

FIG. 11 is a diagram illustrating a panoramic image with an optical axis direction of the imaging unit as a central axis.

FIG. 12A is a diagram illustrating a case in which processing has been performed based on the assumption that luggage is piled when luggage is not actually piled on a pallet, and FIG. 12B is a diagram illustrating a case in which processing has been performed based on the assumption that luggage is not piled when luggage is actually piled on the pallet

FIG. 13 is a diagram illustrating an appearance of a forklift when a calibration method is performed.

FIG. 14 is a diagram illustrating a first information image for detecting a panel.

FIG. 15 is a diagram illustrating a panoramic image for detecting right and left longitudinal edges of the panel.

FIG. 16 is a diagram illustrating a panoramic image for detecting front and rear transverse edges of the panel.

FIG. 17 is a flowchart illustrating process details of an article detection method.

FIG. 18 is a flowchart illustrating process details of the article detection method.

FIG. 19 is a flowchart illustrating process details of the article detection method.

FIG. 20 is a flowchart illustrating process details of the article detection method.

FIG. 21 is a flowchart illustrating the calibration method.

FIG. 22 is a diagram illustrating test results for estimating a position and a posture of a pallet.

### DETAILED DESCRIPTION

Hereinafter, an embodiment of the present disclosure will be described in detail with reference to the accompanying drawings.

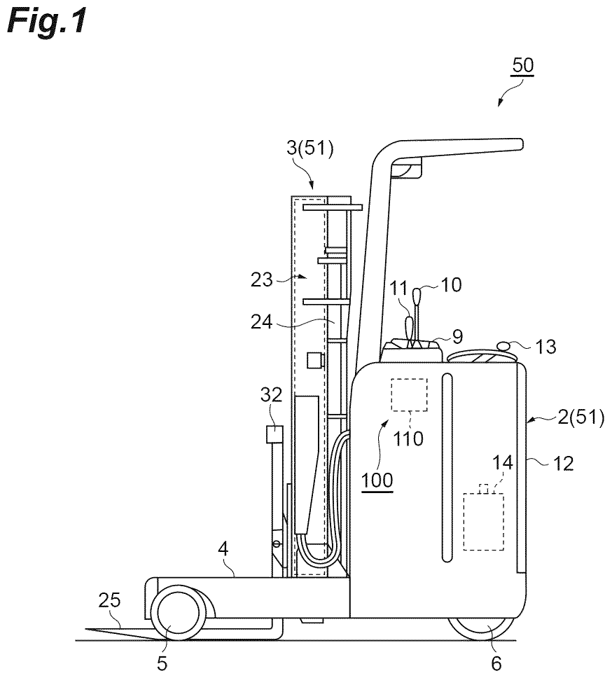

FIG. 1 is a side view of an industrial vehicle including an article detection device according to an embodiment of the present disclosure. In the following description, “right” and “left” are assumed to correspond to “right” and “left” when viewing forward from behind the vehicle. As illustrated in FIG. 1, in this embodiment, a forklift 50 is exemplified as an industrial vehicle for loading/unloading an article. The forklift 50 includes a vehicle body 51, an imaging unit 32 (an image acquiring unit), and an article detection device 100. An imaging unit 32 is, for example, a camera. The image acquiring unit is not limited to the camera, and any device may be employed as long as it can acquire an image. The forklift 50 includes a mobile member 2 and a loading/unloading device 3. The forklift 50 in this embodiment is a reach type forklift and can switch between manual driving which is performed by a driver in a cab 12 and automated driving which is performed by a control unit 110 which will be described later. Alternatively, the forklift 50 may be able to operate by fully automated driving which is performed by the control unit 110.

The mobile member 2 includes a pair of right and left reach legs 4 extending forward. Right and left front wheels 5 are rotatably supported by the right and left reach legs 4. A rear wheel 6 is a rear single wheel and is a driving wheel serving as a turning wheel. A rear part of the mobile member 2 is constituted as a standing type cab 12. A loading/unloading lever 10 for a loading/unloading operation and an accelerator lever 11 for a forward/reverse moving operation are provided in an instrument panel 9 in the front of the cab 12. A steering 13 is provided on the top surface of the instrument panel 9.

The loading/unloading device 3 is provided on the front side of the mobile member 2. When a reach lever of the loading/unloading lever 10 is operated, a reach cylinder (not illustrated) operates telescopically and thus the loading/unloading device 3 moves forward and reversely in a predetermined stroke range along the reach leg 4. The loading/unloading device 3 includes a two-stage mast 23, a lift cylinder 24, a tilt cylinder (not illustrated), and a fork 25. When a lift lever of the loading/unloading lever 10 is operated, the lift cylinder 24 operates telescopically and thus the mast 23 slides up and down, and the fork 25 moves up and down with the sliding of the mast.

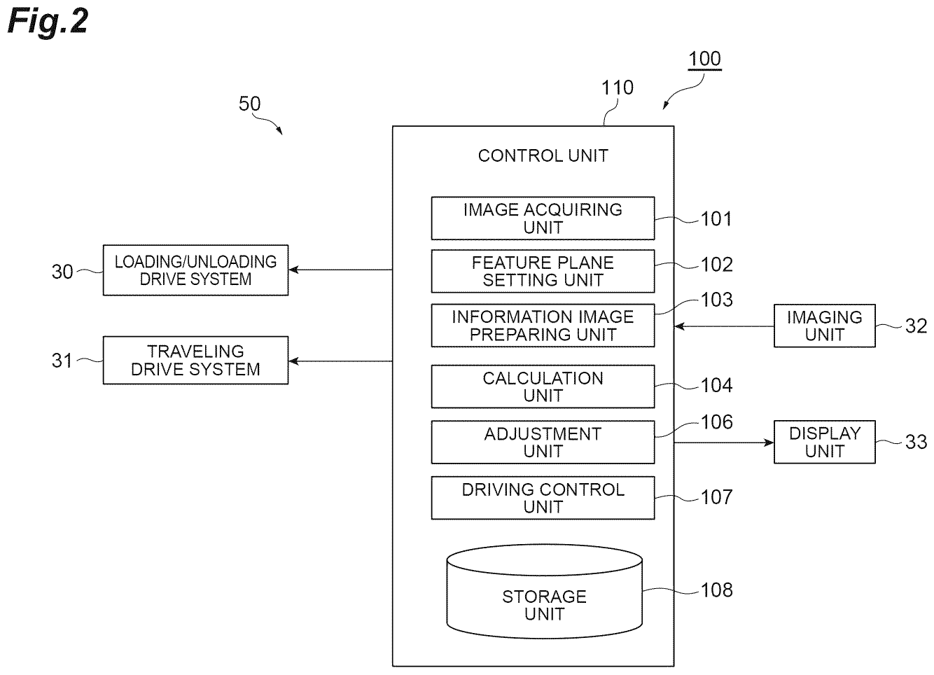

The article detection device 100 of the forklift 50 according to this embodiment will be described below in more detail with reference to FIG. 2. FIG. 2 is a block diagram illustrating the article detection device 100 according to this embodiment and constituents thereof. As illustrated in FIG. 2, the article detection device 100 includes a control unit 110. The control unit 110 of the article detection device 100 is connected to a loading/unloading drive system 30 and a traveling drive system 31 and transmits a control signal thereto. The loading/unloading drive system 30 is a drive system that generates a driving force for operating the loading/unloading device 3. The traveling drive system 31 is a drive system that generates a driving force for causing the mobile member 2 to travel.

The control unit 110 is connected to the imaging unit 32 and acquires an image captured by the imaging unit 32. The imaging unit 32 images the surroundings of the vehicle body 51 of the forklift 50. The imaging unit 32 is provided in a backrest of the fork 25 in the example illustrated in FIG. 1, but may be provided at any position as long as the surroundings of the vehicle body 51 can be imaged. A specific configuration of the imaging unit 32 will be described later. The control unit 110 is connected to a display unit 33 and outputs various types of image data to the display unit 33. When the forklift 50 can operate by fully automated driving under the control of the control unit 110, the display unit 33, the loading/unloading lever 10, the accelerator lever 11, and the steering 13 may not be provided.

The article detection device 100 is a device that detects an article to be loaded/unloaded. The control unit 110 of the article detection device 100 performs control for automatically driving the forklift 50. The control unit 110 detects an article in a stage before the forklift 50 approaches the article to be loaded/unloaded and ascertains a position and a posture of a load/unloading target portion of the article. The control unit 110 ascertains a pitch angle of the article. Accordingly, the control unit 110 approaches the article such that the forklift 50 can smoothly load/unload the article and performs control such that the fork 25 is inserted into the load/unloading target portion.

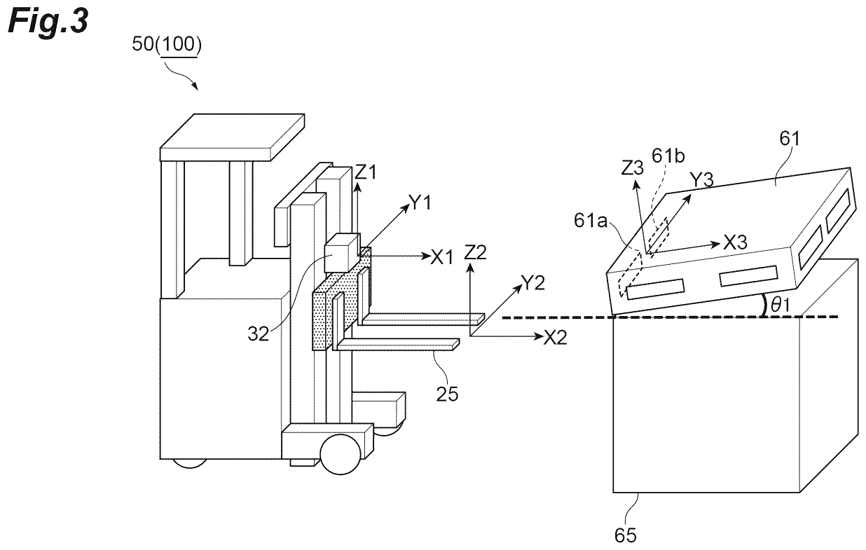

FIG. 3 is a diagram illustrating a state in a step before the fork 25 is inserted into a hole 61b of a front surface 61a (load/unloading target portion) of a pallet 61 (article) on a mount 65 in front of the forklift 50. As illustrated in FIG. 3, a camera coordinate system X1/Y1/Z1 is set at the central position of the imaging unit 32, and a fork coordinate system X2/Y2/Z2 is set at the central position in the transverse direction of tips of a pair of forks 25. For the purpose of convenient explanation, it is assumed that a pallet coordinate system X3/Y3/Z3 is set at the central position of the front surface 61a of the pallet 61. The X1 axis is set to an optical axis direction of the imaging unit 32. The Y1 axis is set to a transverse direction of the imaging unit 32. The X2 axis is set to a longitudinal direction of the forklift 50. The Y2 axis is set to a transverse direction of the forklift 50. The X3 axis is set to a depth direction of the pallet 61. The Y3 axis is set to a transverse direction of the pallet 61. The Z1 axis, the Z2 axis, and the Z3 axis are set to a vertical direction.

In order to insert the fork 25 into a hole 61b of the pallet 61, a height position (a position in the vertical direction), a reach position (a position in the longitudinal direction), and a tilt angle (a slope with respect to a horizontal direction) of the fork 25 needs to be controlled according to a position and a posture of the front surface 61a (the hole 61b) of the pallet 61 and a pitch angle θ1 of the pallet 61. In this specification, the position of the pallet 61 is a position in a three-dimensional space of the origin of the pallet coordinate system X3/Y3/Z3. The posture of the pallet 61 is a yaw posture around a vertical axis of the front surface 61a. The pitch angle θ1 of the pallet 61 is an angle of the X3 axis with respect to the horizontal direction. First, the article detection device 100 acquires the position, the posture, and the pitch angle θ1 of the pallet 61 in the camera coordinate system X1/Y1/Z1 to detect the pallet 61 using the imaging unit 32. Then, the article detection device 100 converts the position, the posture, and the pitch angle θ1 of the pallet 61 to the fork coordinate system X2/Y2/Z2. Accordingly, the forklift 50 is controlled such that the tip of the fork 25 is disposed at an entrance of the hole 61b and the tilt angle of the fork 25 is substantially equal to the pitch angle θ1 of the pallet 61 in a state immediately before the fork 25 is inserted into the hole 61b.

The control unit 110 includes an electronic control unit (ECU) comprehensively managing the device. The ECU is an electronic control unit including a central processing unit (CPU), a read only memory (ROM), a random access memory (RAM), a controller area network (CAN) communication circuit. The ECU realizes various functions, for example, by loading a program stored in the ROM to the RAM and causing the CPU to execute the program loaded to the RAM. The ECU may include a plurality of electronic control units. As illustrated in FIG. 2, the control unit 110 includes an image acquiring unit 101, a feature plane setting unit 102, an information image preparing unit 103 (a first information image preparing unit, a second information image preparing unit), a calculation unit 104 (a first calculation unit, a second calculation unit), an adjustment unit 106, a driving control unit 107, and a storage unit 108.

The image acquiring unit 101 acquires a surroundings image by imaging the surroundings of the vehicle body 51 of the forklift 50.

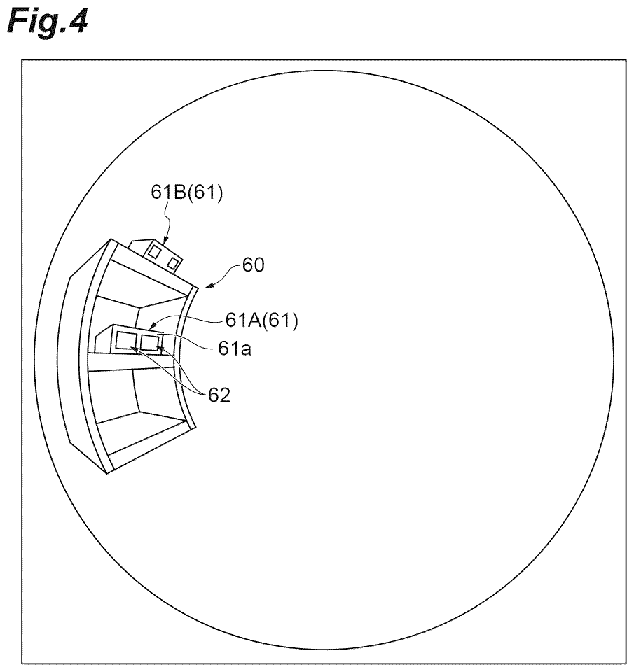

The surroundings image is an image acquired by a fish-eye camera. That is, the imaging unit 32 is constituted by a fish-eye camera. The fish-eye camera is a camera that includes a general fish-eye lens and can monocularly capture an image with a wide field of view of about 180°. FIG. 4 is a diagram illustrating an example of the surroundings image. Since the surroundings image is captured with a wide field of view, an image in which a portion closer to an edge is more greatly curved is acquired as illustrated in FIG. 4. In FIG. 4, nearby structures other than the rack 60 on which the pallet 61 is placed are omitted. Only a pallet 61A is placed on an intermediate stage of the rack 60, and only a pallet 61B is placed on an upper stage thereof. Here, a plurality of pallets 61 may be placed on the rack 60. Luggage on the pallets 61A and 61B is omitted. The front surface 60a of the rack 60 and the front surface 61a of the pallet 61 are illustrated. In the surroundings image, the rack 60 and the pallet 61 are displayed in a state in which they are curved to edge sides.

A lens of a camera constituting the imaging unit 32 is not limited to a fish-eye lens. The imaging unit 32 has only to have such a viewing angle that an image of the pallet 61 can be acquired both at a position at which the forklift 50 gets apart from the rack 60 and at a position at which the forklift 50 gets close to the rack 60. That is, the imaging unit 32 has only to be a camera with a wide field of view that can simultaneously image a front view and a side view of the forklift 50. The imaging unit 32 may employ a wide-angle camera as long as it can capture an image with a wide field of view. The imaging unit 32 may capture an image with a wide field of view by combining a plurality of cameras facing a plurality of directions.

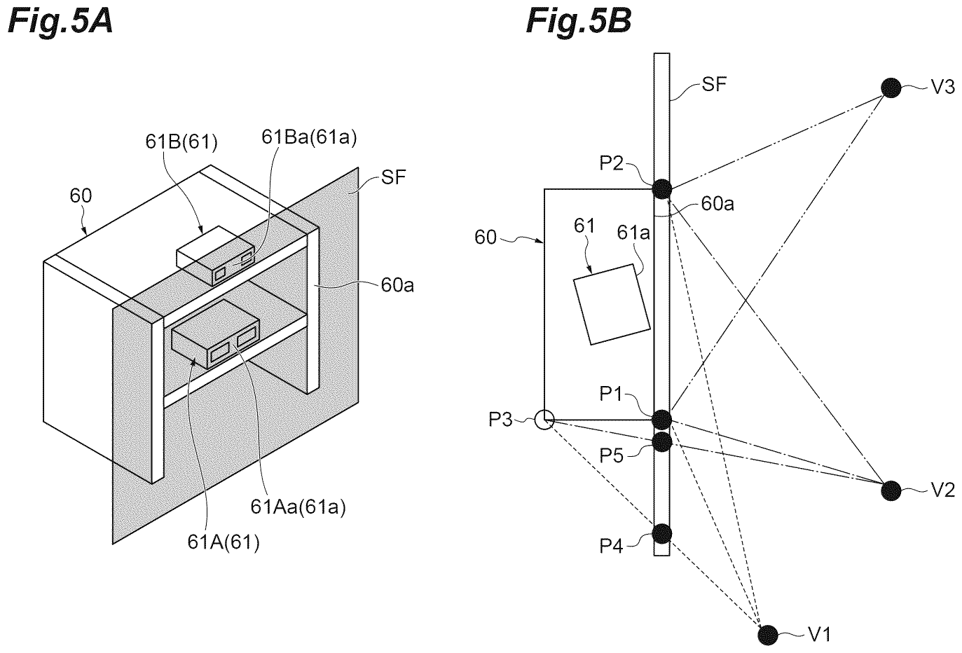

The feature plane setting unit 102 sets a feature plane SF (see FIGS. 5A and 5B) to which features of the front surface 61a of the pallet 61 is projected.

The information image preparing unit 103 prepares a first information image by converting information on the front surface 61a of the pallet 61 to an easily recognizable state based on the surroundings image. The information image preparing unit 103 prepares an information image using the feature plane SF.

The calculation unit 104 detects the pallet 61 to be loaded/unloaded based on the first information image. The calculation unit 104 calculates the position and the posture of the front surface 61a of the pallet 61 to be loaded/unloaded based on the information image.

The driving control unit 107 controls a position or a posture of the vehicle body 51 based on the information on the position and the posture of the front surface 61a of the pallet 61 calculated by the calculation unit 104. The driving control unit 107 may be configured as a control unit separate from the control unit 110 of the article detection device 100. In this case, the control unit 110 of the article detection device 100 outputs a calculation result to the control unit of the driving control unit 107, and the driving control unit 107 performs driving control based on the calculation result from the article detection device 100.

Here, the article detection device 100 performs preparation of the first information image and calculation of the position and the posture of the front surface 61a of the pallet 61 using a known method. The article detection device 100 uses a known method of generating an image obtained by projecting the surroundings image onto a projection plane (the feature plane SF) installed in arbitrary position and posture in the camera coordinate system with a designated resolution (mm/pixel). The article detection device 100 uses a known method of detecting the pallet 61 from the first information image on the projection plane installed in the vicinity of the front surface of the pallet 61 and estimating the substantially position and posture thereof in the camera coordinate system. The article detection device 100 uses a known method of estimating a position of a pallet and a posture around a vertical axis with the substantial position and posture in the camera coordinate system as initial values. A method described in PCT International Publication No. WO2020/189154 A1 may be used as such a known method.

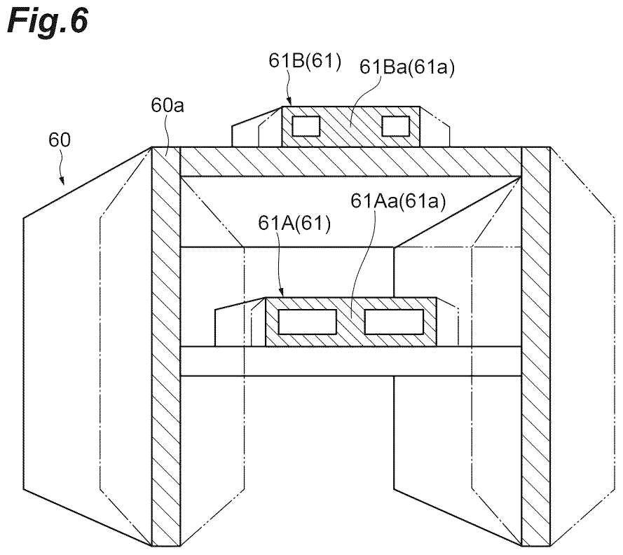

The feature plane SF (projection plane) and the first information image will be described below in detail with reference to FIGS. 5A and 5B and FIG. 6. The following description with reference to FIGS. 5A and 5B and FIG. 6 is only an example, and the present disclosure is not limited to the example. FIG. 5A is a perspective view illustrating a state in which the feature plane SF has been set for the rack 60. FIG. 5B is a plan view schematically illustrating a positional relationship between the feature plane SF and a plurality of viewpoints V1, V2, and V3. FIG. 6 is a diagram illustrating an information image prepared using the feature plane SF.

The feature plane SF is a planar projection plane which is virtually set in a three-dimensional space to prepare an information image. The position or posture of the feature plane SF is information which is known in the setting step. The information image is an image obtained by converting information acquired at a position at which the surroundings image has been acquired to an easily recognizable state. The information acquired at a position at which the surroundings image has been acquired includes information such as positions and sizes of constituent parts of the rack 60 and the pallet 61 when seen from that position. The information image preparing unit 103 which will be described later prepares an information image by projecting the surroundings image to the feature plane SF.

The feature plane SF is a projection plane to which features of the front surface 61a of the pallet 61 are projected. Accordingly, the feature plane SF is set such that features of the front surface 61a of the pallet 61 appear in the information image projected to the feature plane SF. That is, the feature plane SF is a projection plane which is set to a position at which the features of the front surface 61a of the pallet 61 can appear accurately. In the information image of the front surface 61a of the pallet 61 projected to the feature plane SF set in this manner, information indicating features of the front surface 61a appears in a manner in which it can be easily recognized in an image recognizing process. Features of the front surface 61a mean outer features specific to the front surface 61a by which the front surface can be distinguished from other objects in the image. Information indicating features of the front surface 61a includes shape information or size information which can identify the front surface 61a.

For example, the front surface 61a of the pallet 61 has features such as a rectangular shape extending in the width direction and two holes 61b. Since the front surface 61a and the holes 61b of the pallet 61 are displayed to be distorted in the surroundings image (see FIG. 4), it is difficult to identify the shape thereof, it is difficult to ascertain the size thereof, and it is also difficult to detect the shape and the size as features through an image recognizing process. On the other hand, in an image projected onto the feature plane SF, the shapes of the front surface 61a and the holes 61b of the pallet 61 appear accurately without collapsing the shapes thereof. In an image projected onto the feature plane SF, a width and a height of a pallet and a size between a pair of holes 61b for identifying the front surface 61a of the pallet 61 appear in a measurable manner. In an image projected onto the feature plane SF, features of the front surface 61a of the pallet 61 appear accurately. That is, in the image projected onto the feature plane SF, information indicating features of the front surface 61a is displayed in a state in which the information has been converted to an easily recognizable state through an image recognizing process. In this way, the feature plane setting unit 102 sets the feature plane SF at a position at which information indicating features of the front surface 61a of the pallet 61 can be easily recognized.

Here, the information image can most accurately represent shape target features and dimensional features of the front surface 61a when the feature plane SF is set as the front surface 61a of the pallet 61 to be loaded/unloaded. However, in a step in which the pallet 61 to be loaded/unloaded has not been identified (when an article state is not known), the feature plane SF cannot be set as the front surface 61a of the pallet 61. Accordingly, the feature plane setting unit 102 sets the feature plane SF to portions of structures near the pallet 61. The feature plane setting unit 102 sets the feature plane SF to the front surface 60a of the rack 60 as illustrated in FIG. 5A. The front surfaces 61a of the pallets 61 are disposed to substantially match the feature plane SF set on the front surface 60a or to be substantially parallel thereto at a close position. Accordingly, the information image projected onto the feature plane SF set to the front surface 60a of the rack 60 is an image in which features of the front surfaces 61a of the pallets 61 appear satisfactorily.

As illustrated in FIG. 5B, any object present on the feature plane SF is projected to a position at which the object is actually present even in an image projected from any viewpoint. Specifically, one end P1 and the other end P2 of the front surface 60a of the rack 60 are present on the feature plane SF. Accordingly, even when projection from any of the viewpoints V1, V2, and V3 is performed, the positions of the ends P1 and P2 in the information image are constant. On the other hand, an end P3 on the rear surface of the rack 60 is projected to a position of a projection point P4 on the feature plane SF when projection from the viewpoint V1 is performed. The end P3 is projected to a position of a projection point P5 different from the projection point P4 on the feature plane SF when projection from the viewpoint V2 is performed. In this way, an object which is not present on the feature plane SF in a three-dimensional space changes in a position in the information image according to the viewpoint. On the other hand, an object which is present on the feature plane SF in the three-dimensional space maintains its actual shape target feature or an actual dimensional feature in the information image regardless of the viewpoint. The imaging unit 32 does not move actually to the position of the viewpoint V3, and the viewpoint V3 passing through the rack 60 is illustrated for explanation.

In FIG. 6, hatched parts are parts on the feature plane SF or parts present at positions close to the feature plane SF. The parts are substantially constant in positions in the information image even when the viewpoint changes. Here, the front surface 60a of the rack 60 and the front surfaces 61Aa and 61Ba of the pallets 61A and 61B appear in constant positions and sizes in the information image regardless of the viewpoint. Here, the information image preparing unit 103 correlates one pixel with a corresponding size in the information image. That is, what size one pixel in the information image represents as an actual size is uniquely determined. Accordingly, the front surface 60a of the rack 60 and the front surfaces 61Aa and 61Ba of the pallets 61A and 61B are constant in size in the information image regardless of from what viewpoint projection is performed. On the other hand, an object which is not present on the feature plane SF in the three-dimensional space changes in position in the information image with change of the viewpoint. For example, out of parts other than the hatched parts in FIG. 6, a part indicated by a solid line represents a state in which it is seen from the viewpoint V1, a part indicated by a one-dot chain line represents a state in which it is seen from the viewpoint V2, and a part indicated by a two-dot chain line represents a state in which it is seen from the viewpoint V3.

The calculation unit 104 (see FIG. 2) performs calculation associated with the pallet 61 based on the aforementioned relationship between pixels in the first information image and the size of the front surface 61a of the pallet 61. That is, in the first information image, an actual size corresponding to one pixel is uniquely determined. Accordingly, the calculation unit 104 can detect the front surface 61a by reading actual size information of the front surface 61a of the pallet 61 to be loaded/unloaded from the storage unit 108 and extracting an object matching the actual size information form the information image. When the calculation unit 104 detects the front surface 61a of the pallet 61 to be loaded/unloaded in the information image, the front surface 61a of the pallet 61 and the feature plane with which the information image is generated match substantially. Since the three-dimensional position and posture of the feature plane SF are known, the three-dimensional position and posture of the pallet 61 can be calculated based on the detected position of the pallet 61 in the information image, and thus the front surface 61a of the pallet 61 to be loaded/unloaded can be identified.

The adjustment unit 106 (see FIG. 2) improves calculation accuracy in the calculation unit 104 by adjusting conditions for preparing the first information image. The adjustment unit 106 calculates a feature plane SF matching the front surface 61a of the pallet 61 after the pallet 61 to be loaded/unloaded has been detected. Specifically, parameters of an equation of a three-dimensional surface when the information image has been prepared change, the position or posture of the front surface 61a of the pallet 61 in the information image is calculated again, and parameters providing an information image with a maximum degree of match with an edge template are calculated.

Referring back to FIG. 2, the article detection device 100 can calculate the pitch angle θ1 of the pallet 61. Accordingly, the information image preparing unit 103 prepares a second information image by converting information on a pitch angle detection portion of the pallet 61 to an easily recognizable state. The calculation unit 104 calculates the pitch angle θ1 of the pallet 61 based on the second information image. First, a known method which is used for the information image preparing unit 103 and the calculation unit 104 to perform such calculation will be described below.

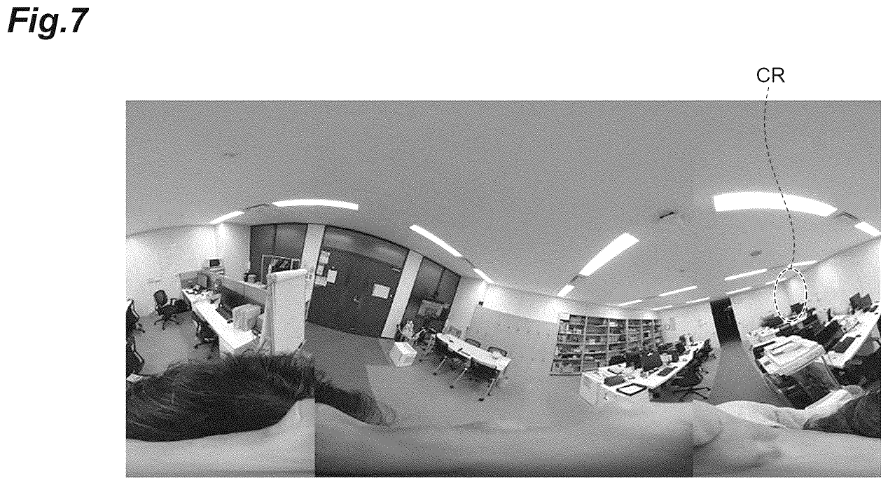

The information image preparing unit 103 prepares a panoramic image illustrated in FIG. 7 by using a known method of converting the surroundings image to a panoramic (equidistant cylindrical) image. The calculation unit 104 uses a known method of detecting a projected curve of a vertical straight line from the panoramic image through Hough transformation. The calculation unit 104 uses a known method of deriving a vertical direction vector in the camera coordinate system from positions in a Hough space of the detected vertical straight line group.

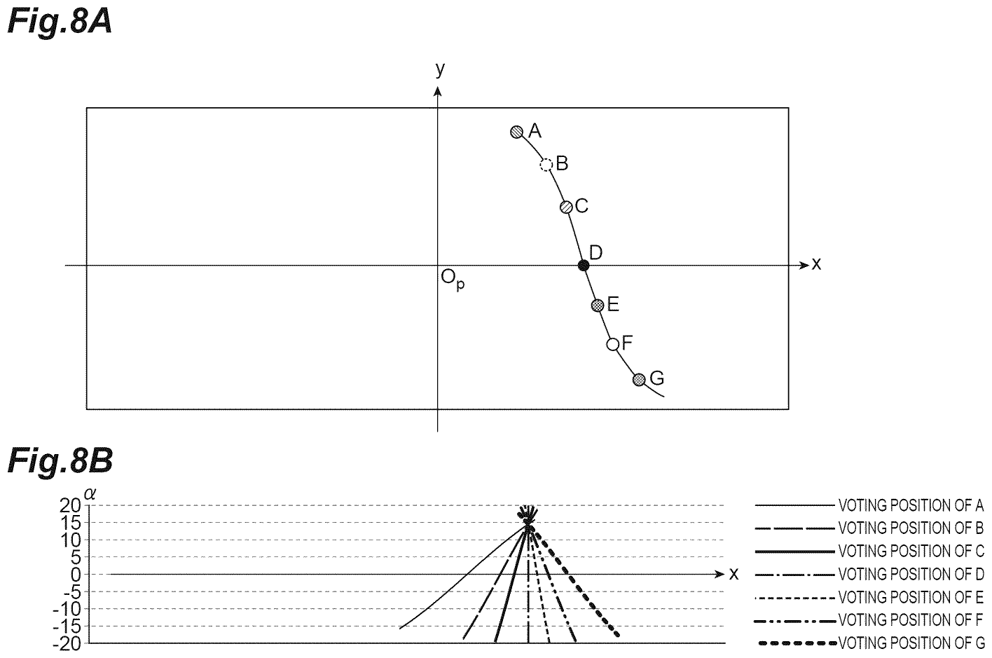

Specifically, the calculation unit 104 detects edge points in the panoramic image illustrated in FIG. 7. For example, a three-dimensional straight line extending in the vertical direction is ascertained from a corner CR between walls of a room. This three-dimensional straight line appears as a curved line in the panoramic image. Accordingly, when edge points of the corner CR are detected, an edge point line forming a curve illustrated in FIG. 8A is detected. The horizontal axis in FIG. 8A represents a horizontal position in the panoramic image, and the vertical axis represents a vertical position in the panoramic image. The calculation unit 104 performs Hough transformation on the edge points. Voting positions in a parameter space after Hough transformation has been performed on the edge points are illustrated in FIG. 8B. The voting positions of the edge points in the same three-dimensional straight line cross one point in the parameter space and exhibit high scores. The horizontal axis in FIG. 8B represents a horizontal position of the three-dimensional straight line, and the vertical axis represents a slope of the three-dimensional straight line with respect to the vertical direction. The calculation unit 104 detects the three-dimensional straight line as positions exhibiting high scores in the parameter space. The calculation unit 104 identifies a three-dimensional plane including the three-dimensional straight line based on the horizontal positions of the detected three-dimensional straight line and the slope with respect to the vertical direction. When two or more three-dimensional straight lines parallel to the three-dimensional straight line of the corner CR can be detected, a direction vector of the three-dimensional straight line of the corner CR in the camera coordinate system is estimated as a crossing line of the three-dimensional plane. The technique of detecting a three-dimensional straight line in the panoramic image and calculating a direction vector thereof is not limited to a vertical straight line, and can also be applied to a three-dimensional parallel line group having a slope close to the vertical direction. Robustness and accuracy are improved by using a plurality of three-dimensional parallel line groups in the technique, but a direction vector of a three-dimensional straight line in the camera coordinate system can be calculated when at least two three-dimensional straight lines parallel to each other can be detected in principle. Accordingly, the information image preparing unit 103 and the calculation unit 104 calculate the pitch angle θ1 of the pallet 61 by performing subsequent processes.

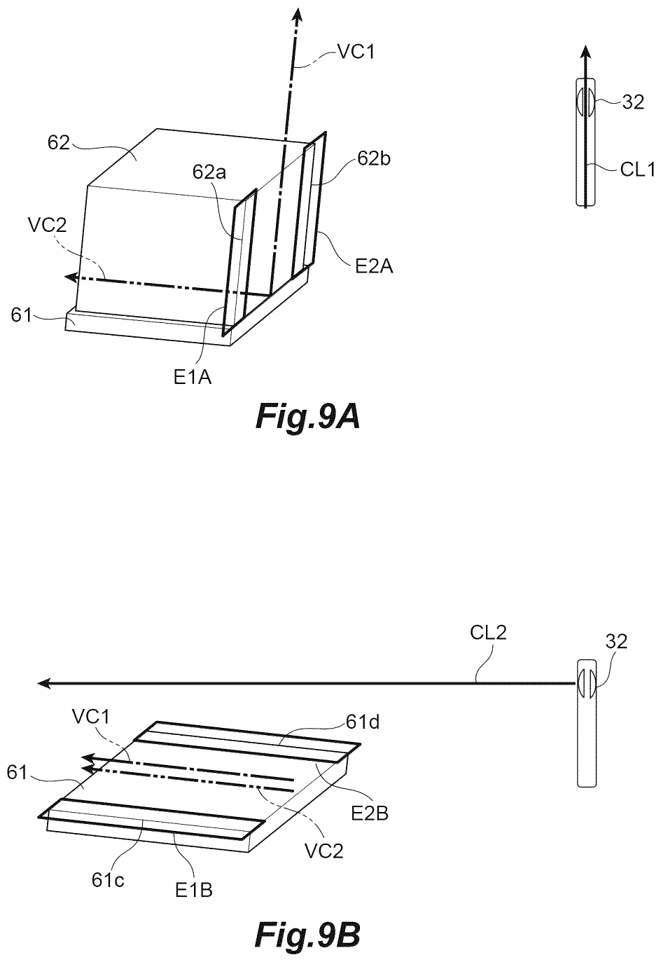

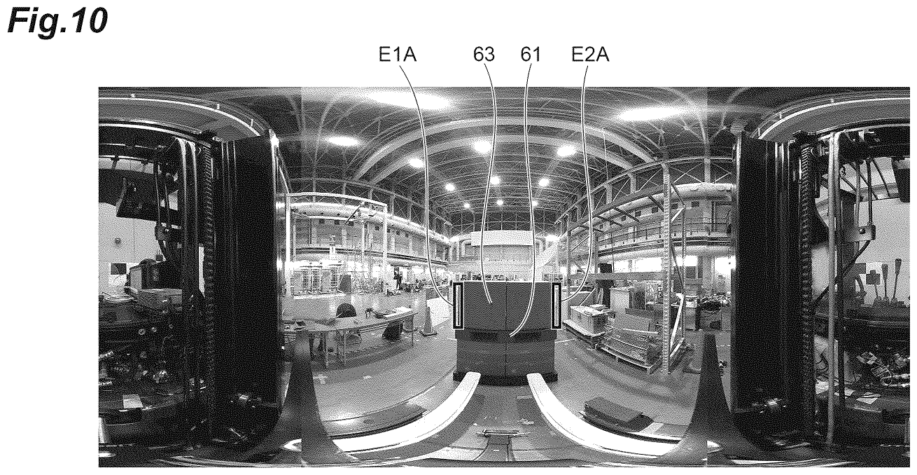

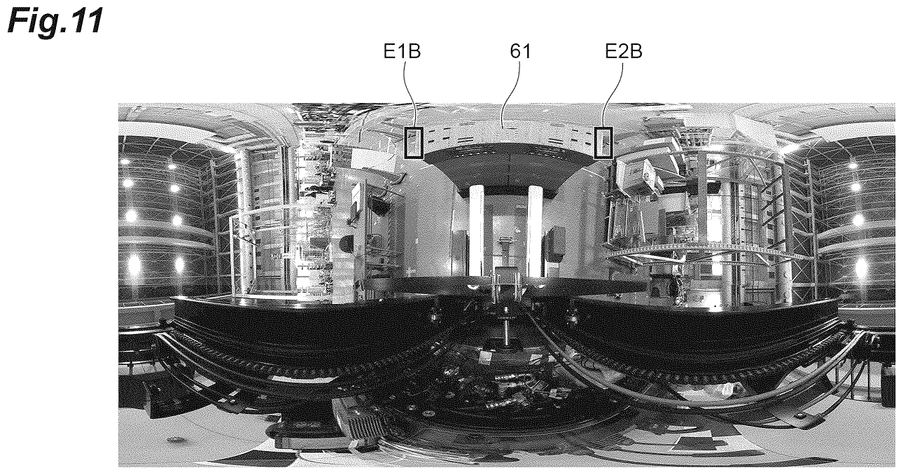

The information image preparing unit 103 prepares the second information image based on the surroundings image of the pallet 61 detected using the first information image. In preparing the second information image, the information image preparing unit 103 prepares the second information image in a first case (see FIG. 9A) in which luggage 62 is piled on the pallet 61 and a second case (see FIG. 9B) in which luggage 62 is not piled on the pallet 61. In the first case, the information image preparing unit 103 prepares a panoramic image with a zenith direction CL1 (vertical direction) of the imaging unit 32 as a central axis as the second information image. This panoramic image is illustrated in FIG. 10. In the second case, the information image preparing unit 103 prepares a panoramic image with an optical axis direction CL2 of the imaging unit 32 as a central axis as the second information image. This panoramic image is illustrated in FIG. 11.

The calculation unit 104 extracts at least two edge candidates for the pallet 61 extending in a specific direction from the second information image and calculates a three-dimensional direction vector indicating the pitch angle of the pallet 61 from the edge candidates. The calculation unit 104 extracts the edge candidates from one side (left side) and the other side (right side) in the transverse direction of the loading/unloading target from the second information image. Here, the loading/unloading target includes both a case including only the pallet 61 in which luggage 62 is not piled and a case including a combination of the pallet 61 in which luggage 62 is piled and the luggage 62.

Specifically, when luggage 62 having a rectangular parallelepiped shape such as a cardboard box is piled on the pallet 61 as illustrated in FIG. 9A, there is a three-dimensional parallel line group in the substantially vertical direction (specific direction) including edges 62a and 62b at the right and left ends of the luggage 62. The calculation unit 104 can calculate a three-dimensional direction vector VC2 indicating the pitch angle of the pallet 61 from a three-dimensional direction vector VC1 in the specific direction acquired based on the edges 62a and 62b. In this embodiment, the edges 62a and 62b are used as pitch angle detection portions.

First, the calculation unit 104 can acquire the position and the posture of the pallet 61 in the camera coordinate system using the first information image. Accordingly, the calculation unit 104 can predict appearance areas E1A and E2A of the edges 62a and 62b of the luggage 62 on the pallet 61 in the panoramic image (see FIGS. 9A and 10). The calculation unit 104 detects projection curves of the three-dimensional straight lines of the edges 62a and 62b in the appearance areas E1A and E2A in the panoramic image.

As illustrated in FIG. 9A, the calculation unit 104 estimates the three-dimensional direction vector VC1 in the specific direction from the detected projection curves of the two (or two or more) three-dimensional straight lines based on the edges 62a and 62b. The calculation unit 104 calculates the three-dimensional direction vector VC2 indicating the pitch angle of the pallet 61 from the estimated three-dimensional direction vector VC1. The three-dimensional direction vector VC2 indicates a direction in which the holes 61b extend, and is a direction which is perpendicular to the three-dimensional direction vector VC1 and perpendicular to the transverse direction of the pallet 61.

As illustrated in FIG. 9B, there is a three-dimensional parallel line group in the substantially longitudinal direction (specific direction) including right and left edges 61c and 61d of the top surface of the pallet 61 in the pallet 61 in which luggage 62 is not piled. The calculation unit 104 can calculate the three-dimensional direction vector VC2 indicating the pitch angle of the pallet 61 from the three-dimensional direction vector VC1 in the specific direction which is acquired based on the edges 61c and 61d. In this embodiment, the edges 61c and 61d are used as pitch angle detection portions.

First, the calculation unit 104 can acquire the position and the posture of the pallet 61 in the camera coordinate system using the first information image. Accordingly, the calculation unit 104 can predict appearance areas E1B and E2B of the edges 61c and 61d of the top surface of the pallet 61 in the panoramic image (see FIGS. 9B and 11). The calculation unit 104 detects projection curves of the two (or more) three-dimensional straight lines of the edges 61c and 61d in the appearance areas E1B and E2B in the panoramic image using the technique described above with reference to FIGS. 8A and 8B.

As illustrated in FIG. 9B, the calculation unit 104 estimates the three-dimensional direction vector VC1 in the specific direction from the detected projection curves of two (or two or more) three-dimensional straight lines based on the edges 61c and 61d. The calculation unit 104 calculates the three-dimensional direction vector VC2 indicating the pitch angle of the pallet 61 from the estimated three-dimensional direction vector VC1. The three-dimensional direction vector VC2 indicates a direction in which the hole 61b extends and is the three-dimensional direction vector VC1 itself.

Here, scores when Hough transformation is performed on the edge points in the appearance areas E1A, E2A, E1B, and E2B correspond to lengths of the detected two-dimensional projection lines. Since the longitudinal lengths of the appearance areas E1A, E2A, E1B, and E2B are ideal lengths, whether there are edges in the appearance areas E1A, E2A, E1B, and E2B can be determined based on a ratio of the scores to the longitudinal lengths. Accordingly, the calculation unit 104 performs Hough transformation of the edge points in a specific area for extracting edge candidates in the second information image and determines that there are edge candidates in the specific area when the acquired length of the straight line is equal to or greater than a predetermined distance.

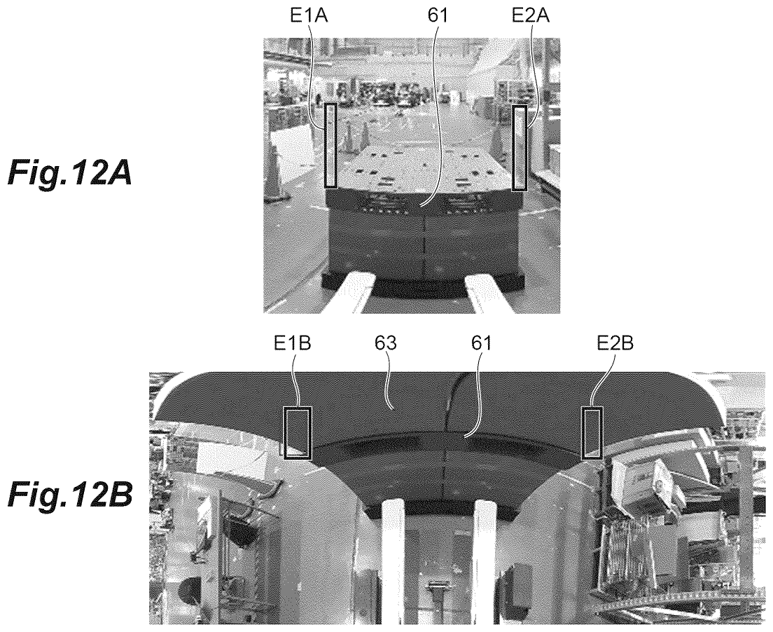

When luggage 62 is not actually piled on the pallet 61 but processing is performed based on the assumption that luggage 62 is piled thereon, the calculation unit 104 can determine that luggage 62 is not piled because sufficient edges are not present in the appearance areas E1A and E2A as illustrated in FIG. 12A and the ratio thereof is small. When luggage 62 is actually pile but processing is performed based on the assumption that luggage 62 is not piled, it can be determined that luggage 62 is piled because the right and left edges of the top surface of the pallet 61 in the appearance areas E1B and E2B are hidden by the luggage 62 as illustrated in FIG. 12B, projection curves are not acquired, and the ratio of scores is small. In many cases, since an effective result is obtained in any one case, the case is employed. Many straight lines in the longitudinal direction may be projected on the background in the panoramic image when it is assumed that luggage 62 is piled. Accordingly, straight lines in the appearance areas E1A and E2A are not detected in a state in which luggage 62 is not piled. In this case, straight lines can be obtained through processing based on the assumption that luggage 62 is not piled. Accordingly, when an effective result is obtained in both cases, the result based on processing based on the assumption that luggage 62 is not piled is employed.

As described above, the information image preparing unit 103 prepares both the second information image with the zenith direction CL1 as a central axis and the second information image with the optical axis direction CL2 as a central axis. The calculation unit 104 employs the result of the second information image with the optical axis direction CL2 as a central axis when an effective result is obtained in any of the second information images.

The calculation unit 104 converts information of the position and the posture of the pallet 61 in the camera coordinate system acquired from the first information image and the direction of the holes 61b acquired from the second information image to the fork coordinate system based on a relationship acquired through calibration between the camera coordinate system and the fork coordinate system. Accordingly, the calculation unit 104 calculates the pitch angle θ1 of the pallet 61 from the direction of the holes 61b in the fork coordinate system.

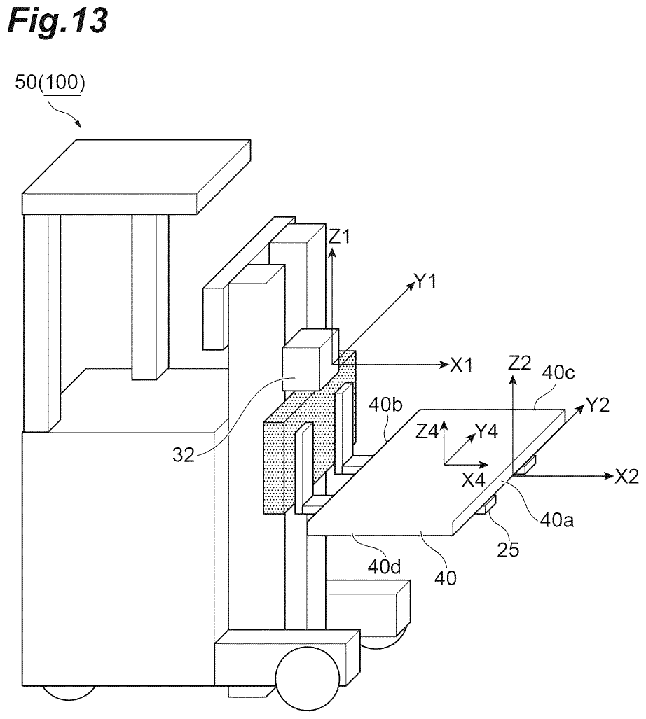

The calibration between the camera coordinate system and the fork coordinate system will be described below. As illustrated in FIG. 13, since the imaging unit 32 is fixed to the backrest of the fork 25, the imaging unit 32 moves in the vertical direction with movement in the vertical direction of the fork 25. Accordingly, the relationship between the camera coordinate system and the fork coordinate system does not change before and after movement of the fork 25. The relationship between the camera coordinate system and the fork coordinate system changes before and after movement of the fork 25 according to the installation position of the imaging unit 32. In this case, every movement, calibration between the camera coordinate system and the fork coordinate system needs to be performed, or an amount of movement of the fork coordinate system from an internal sensor of the forklift 50 needs to be acquired to update the relationship between the camera coordinate system and the fork coordinate system.

In this embodiment, a rectangular panel 40 with a known size is placed on the fork 25 before work by the forklift 50 is started. At this time, the center of a transverse edge 40a on the front side matches the origin of the fork coordinate system, transverse edges 40a and 40b are parallel to the Y2 axis of the fork coordinate system, and longitudinal edges 40c and 40d are parallel to the X2 axis of the fork coordinate system. That is, a panel coordinate system with X4/Y4/Z4 axes indicating the position and the posture of the panel 40 (see FIG. 13) is set at the center of the panel 40, and these axes are parallel to the X2/Y2/Z2 axes of the fork coordinate system.

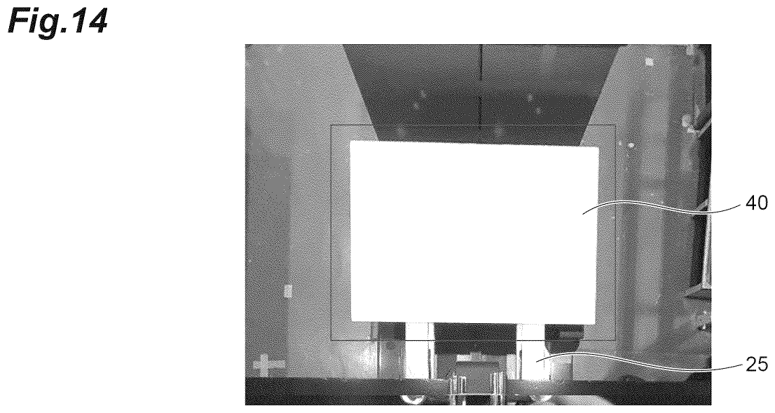

Then, as illustrated in FIG. 14, the information image preparing unit 103 prepares a first information image based on a feature plane set in the vicinity of the top surface of the fork 25 based on a surroundings image. The calculation unit 104 detects the panel 40 from the first information image and calculates the position and the posture of the panel 40 in the camera coordinate system. At this time, the direction of the X4 axis of the panel 40 is maintained in the initially set state. Accordingly, there is a difference between the projection image and the top view of the panel 40. Accordingly, the calculation unit 104 estimates the directions in the camera coordinate system with the X4 axis and the Y4 axis using the following method.

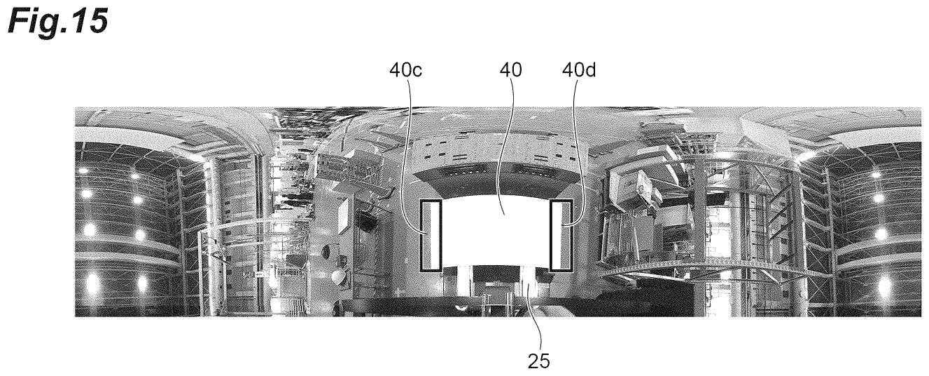

In the same was as calculating the three-dimensional direction vectors of the right and left edges of the top surface of the pallet 61, the information image preparing unit 103 simulatively considers the optical axis direction of the imaging unit 32 as the vertical direction, converts the surroundings image to a panoramic image as illustrated in FIG. 15, and prepares a second information image. The calculation unit 104 calculates a longitudinal direction vector in the camera coordinate system of the right and left longitudinal edges 40c and 40d of the panel 40 based on the second information image.

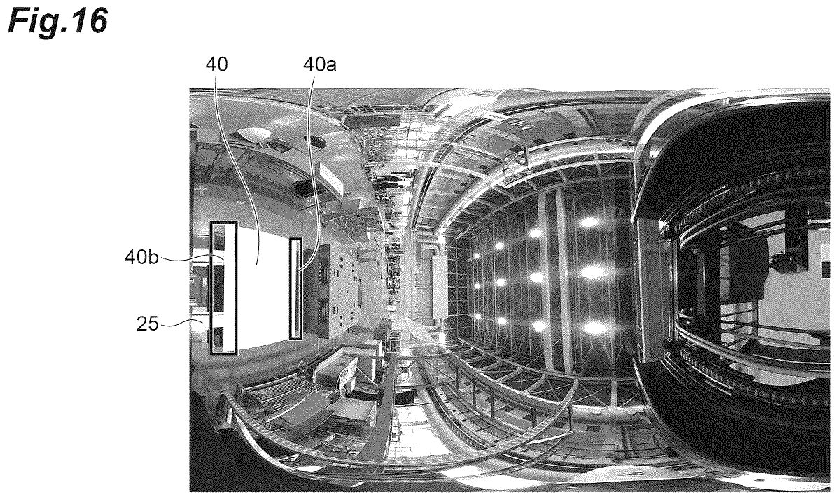

In order to calculate direction vectors of the transverse edges 40a and 40b on the front and rear sides of the panel 40, the information image preparing unit 103 simulatively considers the transverse direction of the imaging unit 32 as the vertical direction, converts the surroundings image to a panoramic image as illustrated in FIG. 16, and prepares a second information image. The calculation unit 104 calculates a transverse direction vector in the camera coordinate system of the upper and lower transverse edges 40a and 40b of the panel 40 based on the second information image.

The calculation unit 104 calculates a direction vector of the remaining one axis from the vertical direction vector and the transverse direction vector of the panel 40 and updates the posture of the panel in the camera coordinate system. In this way, since the posture is accurately measured, the difference between the projection image and the top view of the panel 40 can be resolved. In order to enhance position estimation accuracy, the posture of the panel in the camera coordinate system is fixed to the updated posture, and the information image preparing unit 103 and the calculation unit 104 calculate the position of the panel 40 in the camera coordinate system based on the first information image again. In the panel coordinate system indicating the calculated position and posture of the panel 40 in the camera coordinate system, the calculation unit 104 calculates the position and the posture of the fork coordinate system in the camera coordinate system in consideration of an offset from the center of the panel 40 to the origin of the fork coordinate system. Here, the panel coordinate system can be converted to the fork coordinate system by offsetting the panel coordinate system by half the length in the longitudinal direction of the panel 40.

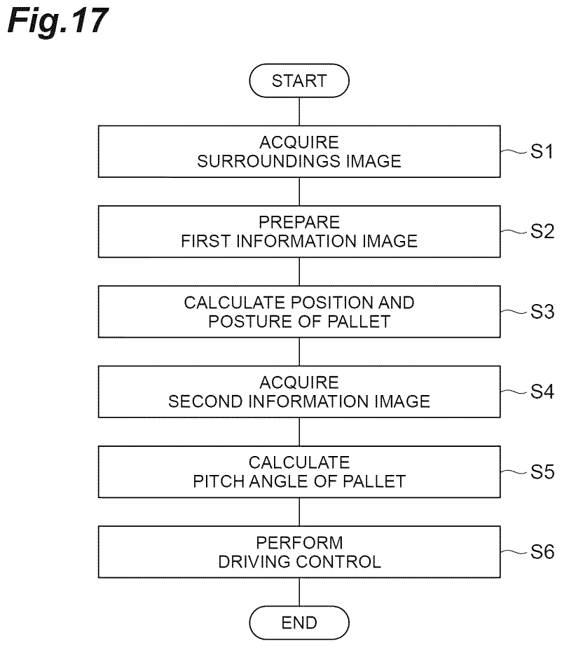

Details of an article detection method according to this embodiment will be described below with reference to FIGS. 17 to 20. FIGS. 17 to 20 are flowcharts illustrating process details of the article detection method. The process details illustrated in FIGS. 17 to 20 are performed by the control unit 110 of the article detection device 100. The process details illustrated in FIGS. 17 to 20 are only examples and the present disclosure is not limited thereto.

As illustrated in FIG. 17, the image acquiring unit 101 of the control unit 110 performs an image acquiring step of acquiring a surroundings image by imaging the surroundings of the vehicle body 51 (Step S1). The feature plane setting unit 102 and the information image preparing unit 103 perform a first information image preparing step of preparing a first information image by converting information on a load/unloading target portion of a pallet 61 to an easily recognizable state based on the surroundings image (Step S2). The calculation unit 104 and the adjustment unit 106 perform a first calculation step of calculating a position and a posture of the load/unloading target portion of the pallet 61 based on the first information image (Step S3). Then, the information image preparing unit 103 performs a second information image preparing step of preparing a second information image by converting information on a pitch angle detection portion of the pallet 61 to an easily recognizable state (Step S4). The calculation unit 104 performs a second calculation step of calculating a pitch angle by extracting at least two edge candidates for the pallet 61 extending in a specific direction from the second information image based on the calculation result of the first calculation step S3 and calculating a three-dimensional direction vector indicating the pitch angle of the pallet 61 from the edge candidates (Step S5). The driving control unit 107 performs a driving control step of performing driving control of the forklift 50 based on the calculation results of the calculation steps S3 and S5 (Step S6).

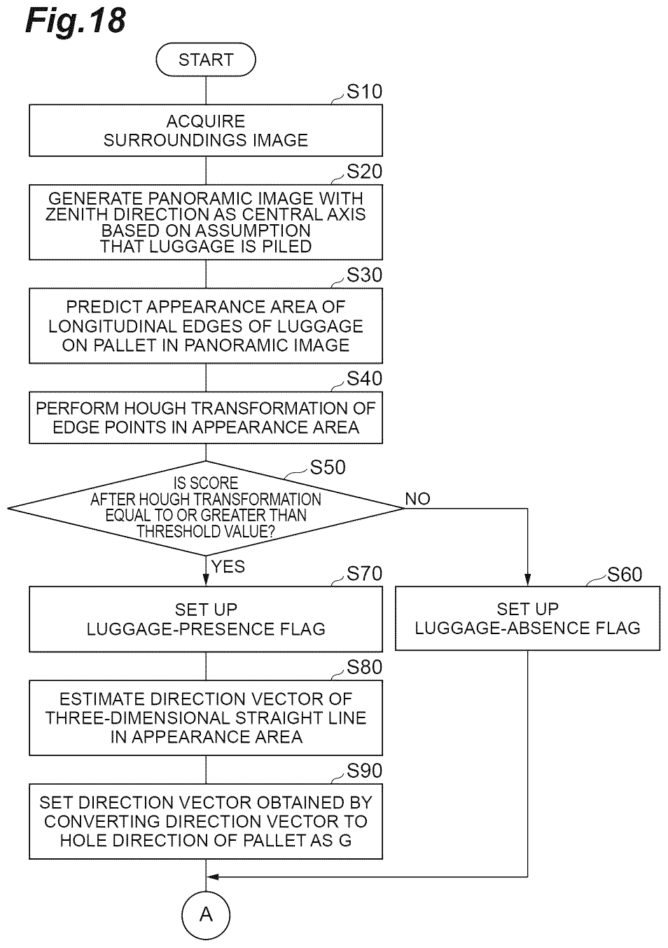

Details of the second information image preparing step S4 and the second calculation step S5 will be described below with reference to FIGS. 18 to 20. As illustrated in FIG. 18, the information image preparing unit 103 acquires the surroundings image (Step S10). The information image preparing unit 103 generates a panoramic image with the zenith direction of the imaging unit 32 as a central axis as the second information image based on the assumption that luggage 62 is piled on the pallet 61 (Step S20). The calculation unit 104 predicts appearance areas E1A and E2A (see FIG. 9A) of a longitudinal edge of the luggage 62 on the pallet 61 in the panoramic image (Step S30). The calculation unit 104 performs Hough transformation of edge points in the appearance areas E1A and E2A (Step S40).

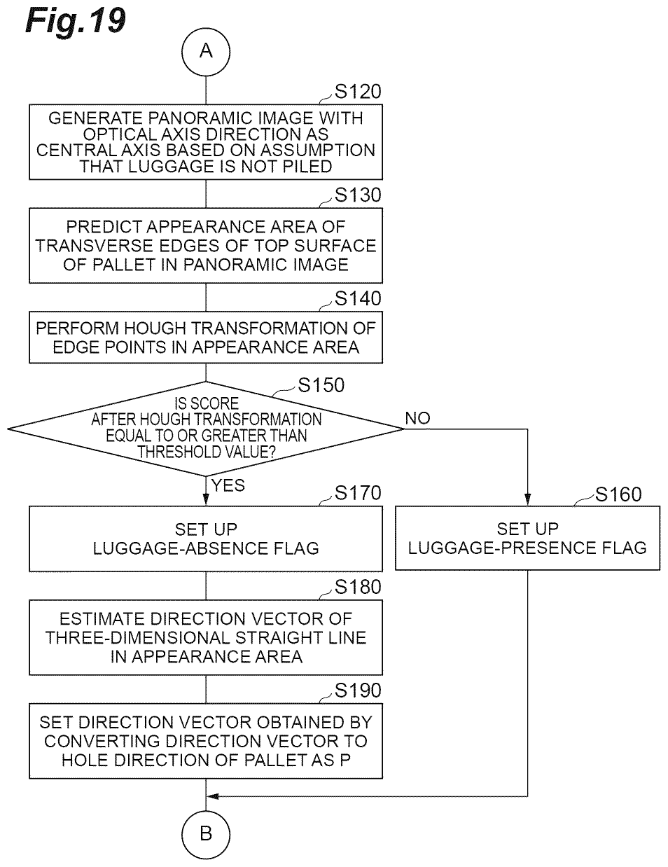

The calculation unit 104 determines whether a score after the Hough transformation has been performed is equal to or greater than a threshold value (Step S50). When it is determined in Step S50 that the score is less than the threshold value, the calculation unit 104 sets up a luggage-absence flag (Step S60) and then performs the routine illustrated in FIG. 19. On the other hand, when it is determined in Step S50 that the score is equal to or greater than the threshold value, the calculation unit 104 sets up a luggage-presence flag (Step S70). Then, the calculation unit 104 estimates a direction vector of a three-dimensional straight line in the appearance areas E1A and E2A (Step S80). The calculation unit 104 defines a direction vector obtained by converting the direction vector to a direction of a hole 61b of the pallet 61 as “G” (Step S90).

As illustrated in FIG. 19, the information image preparing unit 103 generates a panoramic image with the optical axis direction of the imaging unit 32 as a central axis as the second information image based on the assumption that luggage 62 is not present on the pallet 61 (Step S120). The calculation unit 104 predicts appearance areas E1B and E2B of edges (see FIG. 9B) of a top surface of the pallet 61 in the panoramic image (Step S130). The calculation unit 104 performs Hough transformation of edge points in the appearance areas E1B and E2B (Step 140).

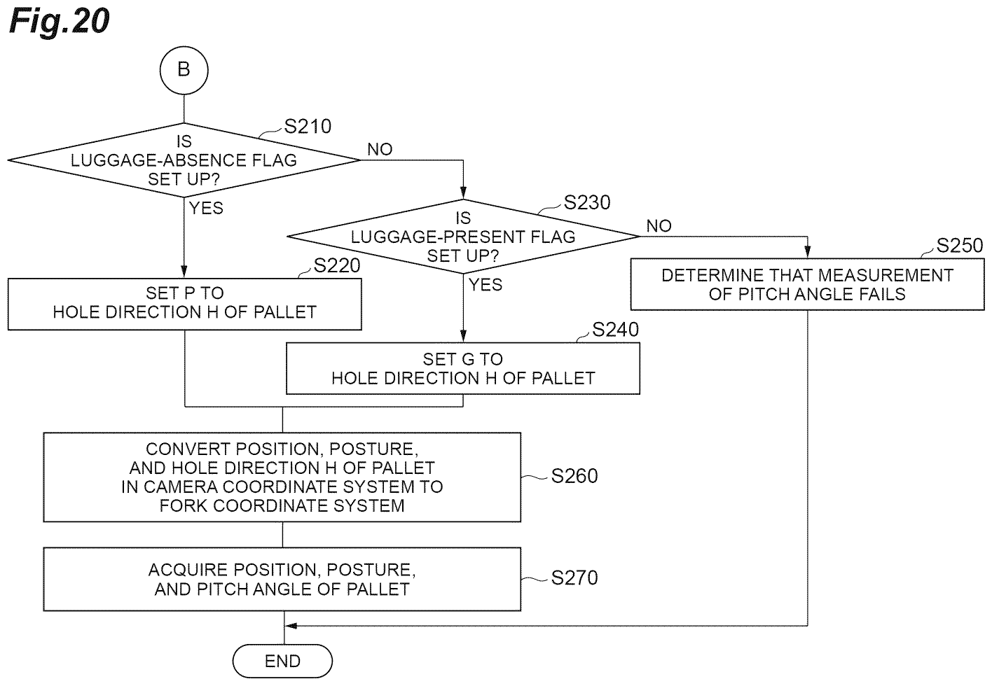

The calculation unit 104 determines whether a score after the Hough transformation has been performed is equal to or greater than a threshold value (Step S150). When it is determined in Step S150 that the score is less than the threshold value, the calculation unit 104 sets up the luggage-presence flag (Step S160) and then performs the routine illustrated in FIG. 20. On the other hand, when it is determined in Step S150 that the score is equal to or greater than the threshold value, the calculation unit 104 sets up the luggage-absence flag (Step S170). Then, the calculation unit 104 estimates a direction vector of a three-dimensional straight line in the appearance areas E1B and E2B (Step S180). The calculation unit 104 defines a direction vector obtained by converting the direction vector to the direction of the hole 61b of the pallet 61 as “P” (Step S190).

As illustrated in FIG. 20, the calculation unit 104 determines whether the luggage-absence flag is set up (Step S210). When it is determined in Step S210 that the luggage-absence flag is set up, the calculation unit 104 sets “P” to a hole direction H of the pallet 61 (Step S220). On the other hand, when it is determined in Step S210 that the luggage-absence flag is not set up, the calculation unit 104 determines whether the luggage-presence flag is set up (Step S230). When it is determined in Step S230 that the luggage-presence flag is set up, the calculation unit 104 sets “G” to the hole direction H of the pallet (Step S240). On the other hand, when it is determined in Step S230 that the luggage-presence flag is not set up, the calculation unit 104 determines that measurement of the pitch angle fails and ends the routine illustrated in FIG. 20 (Step S250).

After Steps S220 and S240 have been performed, the calculation unit 104 converts the position and the posture of the pallet 61 and the hole direction H of the pallet in the camera coordinate system to the fork coordinate system (Step S260). Accordingly, the calculation unit 104 acquires the position, the posture, and the pitch angle of the pallet 61 in the fork coordinate system (Step S270). When the process of Step S270 ends, the routine illustrated in FIG. 20 ends.

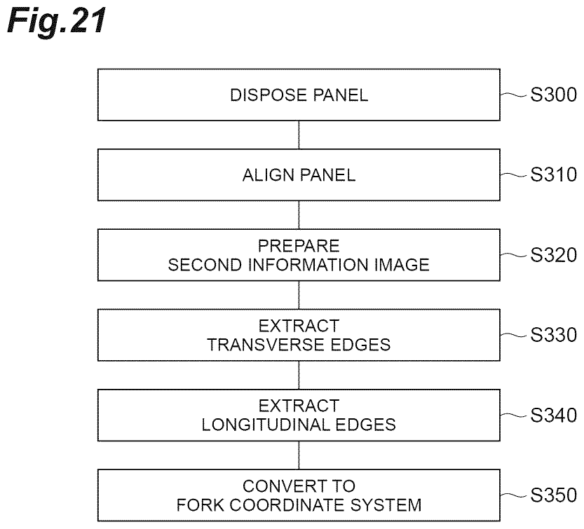

A calibration method of the imaging unit 32 which is used in the article detection device 100 will be described below with reference to FIG. 21. First, a step of placing a calibration panel 40 on a fork 25 is performed (Step S300). Then, a step of aligning the center of the panel 40 with the origin of the fork coordinate system is performed (Step S310). Then, a step of preparing a second information image by converting information on longitudinal and transverse edges of the panel 40 to an easily recognizable state is performed (Step S320). The longitudinal and transverse edges are two edges on the right and left sides in the longitudinal direction of outer lines of a plain panel and two edges on the upper and lower sides in the transverse direction thereof. Then, a step of extracting transverse edges of the panel 40 extending in the transverse direction from the second information image is performed (Step S330). Then, a step of extracting the longitudinal edges of the panel 40 extending in the longitudinal direction from the second information image is performed (Step S340). Then, a step of calculating the position and the posture of the panel 40 in the camera coordinate system based on the edges extracted in Steps S330 and S340 and converting the calculated position and posture to the fork coordinate system is performed (Step S350). In this way, the routine illustrated in FIG. 21 ends.

Operations and advantages of the article detection device 100, the article detection method, and the calibration method according to this embodiment will be described below.

In the article detection device 100 according to this embodiment, the calculation unit 104 (a first calculation unit) can calculate a position and a posture of a front surface 61a of a pallet 61 which is a load/unloading target portion based on a first information image. The article detection device 100 includes the information image preparing unit 103 (a second information image preparing unit) that prepares a second information image by converting information on a pitch angle detection portion of the pallet 61 to an easily recognizable state based on the calculation result from the calculation unit 104. Accordingly, the information image preparing unit 103 can prepare the second information image suitable for calculating the pitch angle of the pallet 61. Here, as illustrated in FIGS. 9A and 9B, when at least two edge candidates are extracted based on the position and the posture of the front surface 61a of the pallet 61 in the second information image, a three-dimensional direction vector VC1 indicating a specific direction can be calculated. A three-dimensional direction vector VC2 indicating the pitch angle of the pallet 61 can be calculated based on the three-dimensional direction vector VC1 indicating the specific direction. Accordingly, the article detection device 100 includes the calculation unit 104 (a second calculation unit) that extracts at least two edge candidates for the pallet 61 extending in the specific direction from the second information image and calculates the three-dimensional direction vector VC2 indicating the pitch angle of the pallet 61 from the edge candidates. Accordingly, the article detection device 100 can easily calculate the pitch angle of the pallet 61 from the surroundings image without using a particular sensor such as a depth sensor. As a result, it is possible to easily acquire the pitch angle of the pallet 61 which is a load/unloading target.

The information image preparing unit 103 may prepare the second information image in the first case in which luggage is piled on the article and the second case in which luggage is not piled on the article in preparing the second information image, prepare the second information image with the zenith direction CL1 of the imaging unit 32 as a central axis in the first case, and prepare the second information image with the optical axis direction CL2 of the imaging unit 32 as a central axis in the second case (see FIGS. 9A and 9B). Accordingly, the calculation unit 104 can calculate the pitch angle of the pallet 61 regardless of whether luggage 62 is piled on the pallet 61.

The calculation unit 104 may extract the edge candidates from one side and the other side in the transverse direction of the loading/unloading target in the second information image. Accordingly, the calculation unit 104 can easily extract edge candidates at easily extractable positions such as right and left edges of the luggage 62 or upper and lower edges of the top surface of the pallet 61.

The information image preparing unit 103 may prepare both the second information image with the zenith direction CL1 as a central axis and the second information image with the optical axis direction CL2 as a central axis, and the calculation unit 104 may employ a result of the second information image with the optical axis direction CL2 as a central axis when results of both the second information images are effective. When the zenith direction CL1 is set as the central axis, many edges are included in the background and thus accuracy is poor. Accordingly, the calculation unit 104 can more accurately calculate the pitch angle by preferentially employing the result of the second information image with the optical axis direction CL2 as the central axis.

The calculation unit 104 may perform Hough transformation of edge points in appearance areas E1A, E2A, E1B, and E2B (the specific areas) for extracting the edge candidates in the second information image and determine that the edge candidates are present in the appearance areas E1A, E2A, E1B, and E2B when a length of an acquired straight line is equal to or greater than a predetermined length. Accordingly, the calculation unit 104 can easily determine whether there is an edge candidate.

The calibration method according to this embodiment is a calibration method for the imaging unit 32 used in the article detection device 100. The calibration method includes a step of disposing a calibration panel 40 on a fork 25, a step of aligning a central portion of the panel 40 with the origin of the fork coordinate system, a step of preparing a second information image by converting information on directions of longitudinal and transverse edges of the panel 40 to an easily recognizable state, a step of extracting longitudinal edges 40c and 40d of the panel 40 included in the second information image, and a step of extracting transverse edges 40a and 40b of the panel 40 included in the second information image.

With this calibration method, a positional relationship between the fork coordinate system and the camera coordinate system can be ascertained from the positional relationship of the panel 40 in the camera coordinate system by disposing the panel 40 on the fork 25 and aligning them. The step of extracting the longitudinal edges 40c and 40d of the panel 40 included in the second information image and the step of extracting the transverse edges 40a and 40b of the panel 40 from the second information image are performed. Accordingly, it is possible to more accurately ascertain the positional relationship of the panel 40 in the camera coordinate system. As a result, it is possible to accurately convert the camera coordinate system to the fork coordinate system.

The article detection method according to this embodiment is an article detection method of detecting an article to be loaded/unloaded. The article detection method includes an image acquiring step S1 of acquiring a surroundings image by imaging the surroundings of the article detection device, a first information image preparing step S2 of preparing a first information image by converting information on a load/unloading target portion of the article to an easily recognizable state based on the surroundings image, a first calculation step S3 of calculating at least one of a position and a posture of the load/unloading target portion based on the first information image, a second information image preparing step S4 of preparing a second information image by converting information on a pitch angle detection portion of the article to an easily recognizable state, and a second calculation step S5 of extracting at least two edge candidates for the article extending in a specific direction and included in the second information image based on a calculation result from the first calculation step S3 and calculating a three-dimensional direction vector indicating a pitch angle of the article from the edge candidates.

With this article detection method, the same operations and advantages as in the article detection device 100 can be achieved.

A test for ascertaining the advantages of this embodiment was carried out. In the test, surroundings images acquired by an omnidirectional camera (Ricoh ThetaV) fixed to an upper center of a backrest of a reach type forklift in a test space were processed by a notebook PC (Thinkpad X1 Extreme).

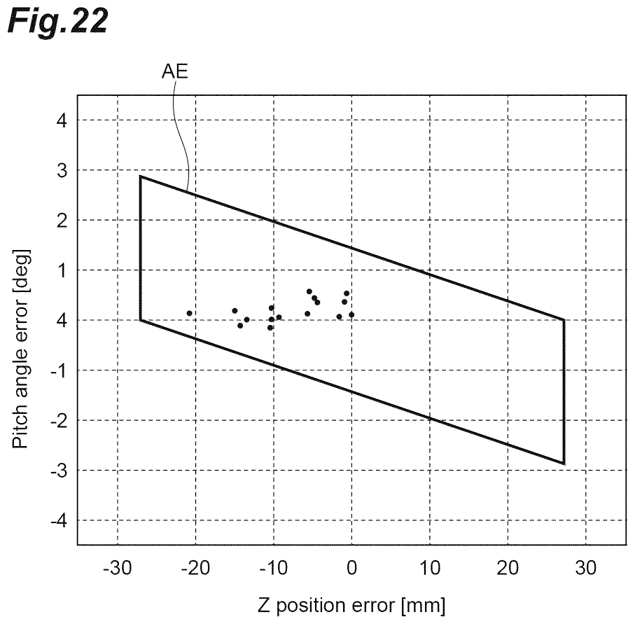

The routines illustrated in FIGS. 18 to 20 were performed, and an image measurement test for a position and a posture in the fork coordinate system of a pallet tilted at a pitch angle was performed. Total 18 surroundings images of “luggage: 2 types×fork height: 3 types×pallet tilt: 3 types” were acquired in the test space, and the position and the posture of the pallet were estimated based on the surroundings images. Evaluation results on whether the forks could be safely inserted into the holes of the pallet when the fork was controlled based on the estimated values are illustrated in FIG. 22. A quadrangle in FIG. 22 indicates an allowable range of a measurement error AE for safely inserting the forks into the holes of the pallet. As illustrated in FIG. 22, errors of all the estimated values (dots in the drawing) of 16 surroundings images except for two examples with luggage (a pallet failed to be detected) are included in the allowable range of the measurement error AE, and thus excellent estimation results were acquired.

The present disclosure is not limited to the aforementioned embodiment.

For example, the industrial vehicle is not limited to a forklift, and may be a manual forklift (a pallet jack) including a power source such as a battery. The article is not limited to a pallet.

When the size is known, the shape of the panel 40 may be a square. In this case, methods of calculating longitudinal edges and transverse edges are the same as those when the panel 40 has a rectangular shape.

When portions corresponding to the longitudinal edges 40c and 40d or the transverse edges 40a and 40b can be detected, the shape of the panel is not limited to a rectangle or a square. For example, a figure with a known size may be drawn on the top surface of a panel, and a longitudinal direction vector in the camera coordinate system of the right and left longitudinal edges of the figure and a transverse direction vector in the camera coordinate system of the upper and lower transverse edges of the figure may be calculated on the basis of the second information image. The drawn figure is preferably a rectangle or a square, but the shape is not particularly limited as long as it has portions corresponding to the longitudinal edges 40c and 40d or the transverse edges 40a and 40b.

In a more specific calibration method, a panel on which a figure is drawn is placed on a fork, and a reference position set in the figure is aligned with the origin of the fork coordinate system. Then, a second information image is prepared by converting information on a pitch angle detection portion of the figure to an easily recognizable state, and edges of the figure extending in a specific direction are extracted from the second information image. Finally, the specific direction in the second information image is converted to another direction, and edges of the figure are extracted.

[Article 1]

An article detection device that detects an article to be loaded/unloaded, the article detection device including:
an image acquiring unit configured to acquire a surroundings image by imaging surroundings of the article detection device;
a first information image preparing unit configured to prepare a first information image by converting information on a load/unloading target portion of the article to an easily recognizable state based on the surroundings image;
a first calculation unit configured to calculate at least one of a position and a posture of the load/unloading target portion based on the first information image;
a second information image preparing unit configured to prepare a second information image by converting information on a pitch angle detection portion of the article to an easily recognizable state; and
a second calculation unit configured to extract at least two edge candidates for the article extending in a specific direction and included in the second information image based on a calculation result from the first calculation unit and to calculate a three-dimensional direction vector indicating a pitch angle of the article from the edge candidates.

[Article 2]

The article detection device according to Article 1, wherein the second information image preparing unit prepares the second information image in a first case in which luggage is piled on the article and a second case in which luggage is not piled on the article in preparing the second information image,
wherein the second information image preparing unit prepares the second information image with a zenith direction of the image acquiring unit as a central axis in the first case, and
wherein the second information image preparing unit prepares the second information image with an optical axis direction of the image acquiring unit as a central axis in the second case.

[Article 3]

The article detection device according to Article 1 or 2, wherein the second calculation unit extracts the edge candidates from one side and the other side in a transverse direction of a loading/unloading target in the second information image.

[Article 4]

The article detection device according to Article 2, wherein the second information image preparing unit prepares both the second information image with the zenith direction as a central axis and the second information image with the optical axis direction as a central axis, and
wherein the second calculation unit employs a result of the second information image with the optical axis direction as a central axis when results of both the second information images are effective.

[Article 5]

The article detection device according to any one of Articles 1 to 4, wherein the second calculation unit performs Hough transformation of edge points in a specific area for extracting the edge candidates in the second information image and determines that the edge candidates are present in the specific area when a length of an acquired straight line is equal to or greater than a predetermined length.

[Article 6]

A calibration method for an image acquiring unit used in an article detection device, the calibration method including:
a step of disposing a calibration panel on a fork;
a step of aligning a central portion of the panel with the origin of a fork coordinate system;
a step of preparing a second information image by converting information on directions of longitudinal and transverse edges of the panel to an easily recognizable state;
a step of extracting a longitudinal edge of the panel included in the second information image; and
a step of extracting a transverse edge of the panel included in the second information image.

[Article 7]

An article detection method of detecting an article to be loaded/unloaded, the article detection method including:
an image acquiring step of acquiring a surroundings image by imaging surroundings of an article detection device;
a first information image preparing step of preparing a first information image by converting information on a load/unloading target portion of the article to an easily recognizable state based on the surroundings image;
a first calculation step of calculating at least one of a position and a posture of the load/unloading target portion based on the first information image;
a second information image preparing step of preparing a second information image by converting information on a pitch angle detection portion of the article to an easily recognizable state; and
a second calculation step of extracting at least two edge candidates for the article extending in a specific direction and included in the second information image based on a calculation result from the first calculation unit and calculating a three-dimensional direction vector indicating a pitch angle of the article from the edge candidates.

### REFERENCE SIGNS LIST

32 . . . Imaging unit (image acquiring unit)
50 . . . Forklift (industrial vehicle)
61 . . . Pallet (article)
61a . . . Front surface (loading/unloading target portion)
62 . . . Luggage
100 . . . Article detection device
101 . . . Image acquiring unit
103 . . . Information image preparing unit (first information image preparing unit, second information image preparing unit)
104 . . . Calculation unit (first calculation unit, second calculation unit)

What is claimed is:

1. An article detection device that detects an article to be loaded/unloaded, the article detection device comprising:
an image acquiring unit configured to acquire a surroundings image by imaging surroundings of the article detection device;
a first information image preparing unit configured to prepare a first information image by converting information on a load/unloading target portion of the article to an easily recognizable state based on the surroundings image;
a first calculation unit configured to calculate at least one of a position and a posture of the load/unloading target portion based on the first information image;
a second information image preparing unit configured to prepare a second information image by converting information on a pitch angle detection portion of the article to an easily recognizable state; and
a second calculation unit configured to extract at least two edge candidates for the article extending in a specific direction and included in the second information image based on a calculation result from the first calculation unit and to calculate a three-dimensional direction vector indicating a pitch angle of the article from the edge candidates.

2. The article detection device according to claim 1, wherein the second information image preparing unit prepares the second information image in a first case in which luggage is piled on the article and a second case in which luggage is not piled on the article in preparing the second information image,
wherein the second information image preparing unit prepares the second information image with a zenith direction of the image acquiring unit as a central axis in the first case, and
wherein the second information image preparing unit prepares the second information image with an optical axis direction of the image acquiring unit as a central axis in the second case.

3. The article detection device according to claim 1, wherein the second calculation unit extracts the edge candidates from one side and the other side in a transverse direction of a loading/unloading target in the second information image.

4. The article detection device according to claim 2, wherein the second information image preparing unit prepares both the second information image with the zenith direction as a central axis and the second information image with the optical axis direction as a central axis, and
wherein the second calculation unit employs a result of the second information image with the optical axis direction as a central axis when results of both the second information images are effective.

5. The article detection device according to claim 1, wherein the second calculation unit performs Hough transformation of edge points in a specific area for extracting the edge candidates in the second information image and determines that the edge candidates are present in the specific area when a length of an acquired straight line is equal to or greater than a predetermined length.

6. A calibration method for an image acquiring unit used in an article detection device, the calibration method comprising:
a step of disposing a calibration panel on a fork;
a step of aligning a central portion of the panel with the origin of a fork coordinate system;
a step of preparing a second information image by converting information on directions of longitudinal and transverse edges of the panel to an easily recognizable state;
a step of extracting a longitudinal edge of the panel included in the second information image; and
a step of extracting a transverse edge of the panel included in the second information image.

7. An article detection method of detecting an article to be loaded/unloaded, the article detection method comprising:
an image acquiring step of acquiring a surroundings image by imaging surroundings of an article detection device;
a first information image preparing step of preparing a first information image by converting information on a load/unloading target portion of the article to an easily recognizable state based on the surroundings image;
a first calculation step of calculating at least one of a position and a posture of the load/unloading target portion based on the first information image;
a second information image preparing step of preparing a second information image by converting information on a pitch angle detection portion of the article to an easily recognizable state; and
a second calculation step of extracting at least two edge candidates for the article extending in a specific direction and included in the second information image based on a calculation result from the first calculation step and calculating a three-dimensional direction vector indicating a pitch angle of the article from the edge candidates.
